(19) United States
(12) Patent Application Publication
(10) Pub. No.: US 2020/0219145 A1
(43) Pub. Date: Jul. 9, 2020

(54) Bidding Agent with Optimized Reach Limitation by Segment

(71) Applicant: Alphonso Inc., Mountain View, CA (US)

(72) Inventors: Lampros Kalampoukas, Brick, NJ (US); Raghu Srinivas Kodige, San Carlos, CA (US); Joe Zachariah, San Jose, CA (US); Richard Andrades, Warminster, PA (US); Saket Gadia, Sunnyvale, CA (US)

(73) Assignee: Alphonso Inc., Mountain View, CA (US)

(21) Appl. No.: 16/241,979

(22) Filed: Jan. 7, 2019

(51) Int. Cl. G06Q 30/02

(52) U.S. Cl. CPC G06Q 30/0275; G06Q 30/0277

(57) ABSTRACT

A system and method for adjusting bid forming in a real-time bidding advertisement auction system. The method may be implemented for a bidding agent or in connection with a campaign database specifying campaign objectives by segment and campaign duration.

### BACKGROUND OF THE INVENTION

### 1. Field of the Invention

The invention relates to a bidding agent, and particularly to a bidding agent for segment selection in an intelligent real-time bidding system.

### 2. Description of the Related Technology

A publisher may generate revenue by including advertising space in its content and work with an ad network to monetize that space. A publisher may include code in its HTML content that refers a browser to the ad network.

Real-time bidding (RTB) is a procedure to buy/sell advertising inventory on a per-impression basis, via programmatic instantaneous auction, like financial markets. With real-time bidding, advertising buyers bid on an impression and, if the bid is won, the buyer's ad is instantly displayed on the publisher's site. Real-time bidding lets advertisers manage and optimize ads from multiple ad networks by granting the advertiser/bidding agency access to a multitude of different networks, allowing them to create and launch advertising campaigns, prioritize networks and allocate percentages of unsold inventory.

Real-time bidding is distinguishable from static auctions by how it is a per-impression way of bidding whereas static auctions are groups of up to several thousand impressions. RTB is promoted as more effective than static auctions for both advertisers and publishers in terms of advertising inventory sold, though the results vary by execution and local conditions.

A typical transaction begins with a user visiting a website. This triggers a bid request that can include various pieces of data such as the user's demographic information, browsing history, location, and the page being loaded. The request goes from the publisher to an ad exchange, which submits it and the accompanying data to multiple advertisers who automatically submit bids in real time to place their ads. Advertisers bid on each ad impression as it is served. The impression goes to the highest bidder and their ad is served on the page. This process is repeated for every ad slot on the page. RTB transactions typically happen within 100 milliseconds (including receiving the bid request and serving the ad) from the moment the ad exchange received the request.

The bidding happens autonomously, and advertisers set maximum bids and budgets for an advertising campaign. The criteria for bidding on types of consumers can be very complex, considering everything from very detailed behavioral profiles to conversion data. Probabilistic models can be used to determine the probability for a click or a conversion given the user history data. This probability can be used to determine the size of the bid for the respective advertising slot.

A Real-time bidding system is shown in U.S. Pat. No. 6,324,519 B1 entitled, “Advertisement Auction System,” and is expressly incorporated by reference herein and discloses an advertisement auction system in which content/opportunity providers announce to advertisers that they have an opportunity to present an advertisement to a consumer, and the advertiser transmits ad characterization information which is correlated with the consumer profile.

Data augmentation may be applied to many problems which involve the use of data to make decisions based on a set of criteria. Data augmentation adds value to data by adding information derived from internal and external sources. Data augmentation may be a way to reduce overfitting of models. Overfitting may arise when a model relies on a small or incomplete data set. Data augmentation systems may improve decision-making by either increasing the amount of data, or by improving methods that make use of the data.

A data augmentation system is shown in U.S. Pat. No. 8,332,334 B2 entitled, “System and Method for Cross Domain Learning for Data Augmentation,” and is expressly incorporated by reference herein and discloses, in part, a system for generating a new target function using a labeled target domain data, a labeled source domain data, and a weighting factors for a labeled source domain data, for evaluating the performance of the new target function to determine if there is a convergence.

Tracking pixels are used on web pages or email, to unobtrusively (usually invisibly) allow confirmation that a user has accessed some content.

Tracking pixels may be used to track information such as who is reading a web page or email, when, and from which computer. They can also be used to see if an email was read or forwarded to someone else, or if a web page was copied to another website.

Often, emails and web pages may refer to content on another server, rather than including the content directly. When an email client or web browser prepares such an email or web page for display, it ordinarily sends a request to the server that is referred to in the content to send additional content.

These requests may include information such as the IP address of the requesting computer, the time the content was requested, the type of web browser that made the request, and the existence of cookies previously set by that server. The additional content may be an ad for insertion in the display of a web page. The ad may be fetched from a third-party ad server, not from the server the main webpage was fetched from. This configuration separates the advertiser from the ad delivery process. Advertisers may include a tracking pixel/web beacon to gather information relating to the ad placement from the consuming device. This allows the potential for the advertisers and/or ad agencies to confirm consumption of ads placed in content delivered by a publisher.

A tracking pixel may be a small (usually transparent) GIF or PNG image (or an image of the same color as the background) that is embedded in an HTML page, usually a page on the web or the content of an email. Tracking pixels may also use HTML IFRAME, style, script, input link, embed, object, and other tags to track usage. Whenever a user opens a webpage or email, such image and other information is downloaded. This download requires the browser to send a request to the server storing that image or information, allowing the organization running that server to keep track of the HTML page.

The use of a tracking agent in connection with online advertisement is shown in U.S Pat. No. 9,105,028 B2 entitled, “Monitoring Clickstream Behavior of Viewers of Online Advertisements and Search Results,” and is expressly incorporated by reference herein and discloses tracking and analyzing a computer user's behavior after viewing a search result or an advertisement to assess the impact of having viewed the search result or advertisement.

Tracking pixels used in web pages and emails may have different purposes. If the tracking pixel is embedded in an email such as an HTML message, the tracking pixel may trigger interaction with an additional server when a user reads the email for the first time and/or each time that the user subsequently loads the email. Whenever a web page (with or without tracking pixel) is downloaded, the server holding the page knows and can store the IP address of the computer requesting the page; this information can therefore be retrieved from the server log files without the need of using tracking pixel. Tracking pixels may be advantageous when the monitoring party does not have access to or trust the server logs. This may happen when a web site owner does not control its web servers (such as in web hotels), because monitoring is done by a third party, or a greater level of detail needs to be recorded than is possible from web log analysis alone.

A tracking pixel may identify the location of a resource that is being requested.

The URL referred to by the tracking pixel can be appended with a data string in various ways while still identifying the same object. The appended data string can be used to better identify the conditions under which the tracking pixel has been loaded. The appended data string may be included in the tracking pixel being sent to a user or may be formed at a user's browser, for example, by a JavaScript included in the tracking pixel or delivered in response to a resource request of the tracking pixel.

For example, an email sent to the address smith@example.org can contain the embedded “image” of with a URL http://smith.com/bug.gif?somebody@example.org. Whenever the user reads the email, the image at this URL is requested. The part of the URL after the question mark is ignored by the server for determining which file to send, but the complete URL is stored in the server's log file. As a result, the file bug.gif is sent and shown in the email reader; at the same time, the server stores the fact that the email sent to smith@example.org has been read.

Tracking pixels may also be used in combination with HTTP cookies like any other object transferred using the HTTP protocol. Tracking pixels have several advantages over other tracking devices. For example, many modern browsers are configured to not allow cookies. In addition, cookies are not compatible with many mobile computing platforms.

U.S. Pat. No. 8,831,987 B2 entitled, “Managing Bids in a Real-time Auction for Advertisements,” and is expressly incorporated by reference herein and shows a system for conducting an auction for advertising across multiple markets.

U.S. Pat. No. 6,324,519 B1 entitled, “Advertisement Auction System,” and is expressly incorporated by reference herein, discloses an advertisement auction system in which content/opportunity providers announce to advertisers that they have an opportunity to present an advertisement to a consumer, and the advertiser transmits ad characterization information which is correlated with the consumer profile.

U.S. Pat. No. 7,856,378 B2 entitled, “Method and System for Facilitating Trading of Media Space” is expressly incorporated herein by reference, discloses a system for trading media space includes a server node which receives requests for media space from buyers and offers of media space from sellers. The server node includes a set of rules for matching one of the requests and one of the offers to form a matched request and offer pair. A delivery system is connected to said server node for facilitating delivery of media content between the buyer and seller of the matched pair.

U.S. Pat. No. 9,129,313 B1 entitled, “System and method for optimizing real-time bidding on online advertisement placements utilizing mixed probability methods” is expressly incorporated herein by reference, discloses a system and method for optimizing real-time bidding on advertisements by utilizing mixed probability methods. The system assigns several probability scores based on various criterion, and then calculates a combined probability score and threshold based on these scores when a real-time bid request is received.

U.S. Pat. No. 9,105,028 B2 entitled, “Monitoring Clickstream Behavior of Viewers of Online Advertisements and Search Results,” and is expressly incorporated by reference herein, discloses tracking and analyzing a computer user's behavior after viewing a search result or a particular advertisement to assess the impact of having viewed the search result or advertisement.

U.S. Pat. No. 8,332,334 B2 entitled, “System and Method for Cross Domain Learning for Data Augmentation,” and is expressly incorporated by reference herein, discloses in part generating a new target function using a labeled target domain data, a labeled source domain data, and a weighting factors for a labeled source domain data, an evaluating a performance of the new target function to determine if there is a convergence.

U.S. Patent Publication No. 2015/0331660 A1 entitled, “Efficient Apparatus and Method for Audio Signature Generation Using Audio Threshold,” is expressly incorporated by reference herein and shows an automatic content recognition system that includes a user device for capturing audio and generating an audio signature.

### SUMMARY OF THE INVENTION

It is an object to provide an enhanced real-time bidding agent to intelligently allocated bids across segments of a target population. It is a further object to adjust the bid allocation based on segment prioritization. It is a further object to adjust the bid allocation base on campaign progress and performance. Several enhancements to real-time bidding systems have been proposed by applicant and include, without limitation: a system for cross-platform data augmentation to facilitate coordination across advertising bidding platforms; a system for bidding optimization reach limitations, which limits the number of eligible users for any ad or brand with the goal of maximizing the number of users that receive at least the minimum impression level and minimizes the number of users which receive more than the maximum impression level; and a bid management system based on the source of the advertising opportunity. Tracking the source of a bid request allows an advertiser to limit the number of impressions which are correlated by limiting the same to an opportunity source. This allows an advertiser to distribute ads over a greater number of ad opportunity sources. For example, bids may be restricted based on the number of successful placements to users of specified apps according to the specified threshold or to visitors of specified websites according to specified thresholds. Another enhanced bid management tool is to infer viewership activity by correlating television viewership information with bid request source, which allows an advertiser to place bids based on a bid request source having an inferred viewership or demographic information without full access to such information. Another enhanced bid management tool is to limit bids based on a subclass of viewership information. This tool allows identification of ad opportunity targets who have been exposed to a designated type of media, for example, sports programming, but to limit placements to users based on a threshold level for users who have viewed a subclass of the programming type. For example, a limited number of ad placements may be allocated to tennis, even if all the sports programming allocation is not filled.

Another enhanced bid management tool may be to limit ad reach by segment in order to reach a maximum ad delivery target and to maximize delivery to preferred segment(s).

The effectiveness of ad placement through bidding platforms, particularly in real-time bidding systems, can be enhanced through management of the bid forming logic and evaluation of available data. It is important to provide enhanced capabilities for an advertiser or agency to manage ad placements according to protocols designed in accordance with placement strategies.

The bidding management enhancements may be used independently or combined with some or all the enhancements described herein and with other bidding management tools.

Demand-side platforms generally have certain campaign management tools which include: budget pacing, which allows a marketer to set a daily or weekly campaign budget that the ad server uses to make appropriate bids; cross-device capabilities, which are able to use functions such as targeting, frequency, campaign, budget pacing, creative optimization, etc. across multiple devices; estimate and projections, which allows estimates of available impressions and their costs; mobile rich media rich capabilities, which support rich media mobile ads that involve user interaction; in-app ads, which allows for ads to be placed in mobile apps; contextual textual targeting, which is able to match a marketer's ad with specific content on a site or page; geotargeting, which allows a marketer to tailor ads based on consumer general region, state, or designated market area; or frequency capping, which allows a marketer to set a limit on how many times a consumer sees their ad. The target population may be divided into segments which may be used to enhance targeting strategies.

Tracking pixel data may be used by a data augmentation system to optimize bid placements across one or more bidding platforms in an RTB ad exchange system. The tracking pixel data may be used to inform bidding and to change bidding behavior. A tracking pixel server may be configured to periodically assess certain metrics, such as the reach of the advertisement. Such metrics may be compiled into reports and sent to the plurality of bidding platform servers to further inform bidding. Such reports may also be sent to advertisers to allow advertisers the opportunity to assess the status of the campaign.

Advertisers may wish for users to receive a perceived optimal number of impressions of an ad or campaign. An advertiser may specify a desired minimum number of impressions for an advertising target. An advertiser may also specify a maximum number of impressions each target receives. An advertiser may prefer that an individual targeted user receive more than a minimum number of impressions, but less than the threshold.

An advertising campaign may seek to maximize the number of users who receive an optimal number of exposures to an ad. This may be achieved by limiting the reach of the campaign, rather than allowing a bidding agent to submit bids on ad opportunities for any user satisfying the campaign criteria. An unlimited pool of users receiving impressions often results in poor outcomes for the advertiser by providing many users with less than the minimum number of impressions to be effective. The campaign may reach the overall limit of impressions before a substantial number of users has reached the minimum number of impressions for the ad to be effective. On the other hand, a limited set of users are more likely to receive multiple impressions before the overall limit is reached. This may be accomplished by limiting the number of users who are eligible to receive bids. As users receive the minimal number of impressions, the number of unique users may be increased by removing the user from ad placement eligibility when that user has received the minimal of placements.

An advertiser may view the target audience by more than one segment. In addition, an advertiser may seek to use targeting strategies that differ by segment. In each time window, it may be desirable to deliver a particular ad to a population having three segments. One way segments may be established is by using successively narrowing targeting criteria. For example, a 3-segment population may be comprised of the entire population of individuals who have seen any episode of a show. A “more-preferred” segment may be the subset of those individuals who have seen an episode in a season of a show. And a “most-preferred” segment may be the subset who have seen a specific episode. Maximizing the number of placements to the most-preferred segment while still reaching the target number of placements over a period may be accomplished by utilizing bid criteria which limits the percentage of bids made for members of segments other than the most preferred segment. The limitation may increase as the preference for the segment decreases. The system monitors performance of the bid placement campaign over the elapsed time and/or remaining time in a campaign window. Bid and impression performance may be used to adjust bid forming logic. At the initiation of a campaign there may be no segment limitations. The segment of a successful bid may be recorded and the bidding may be limited based on segment performance. The initial limitation may be established based on the rate of progress toward campaign objectives and temporal progress of the campaign. Machine learning, or artificial intelligence, may be applied to enhance the efficiency of both parameters, with experience.

Within each segment, a bid management system may maximize the number of users who receive an optimal number of ad impressions. The system may receive tracking pixel data signifying that a user has been exposed to an ad placement and update an impression count for a user that has been exposed to an eligible ad placement. The system may manage a list that contains a limited set of identifications of users eligible to receive ad impressions based on one or more tracking pixel identifiers, determine whether the updating results in eligible users reaching the optimum range ad impressions, and remove use identifications from the list of eligible users that have reach the optimum range of ad impressions from the list and replacing the user identifications with new user identifications eligible to receive ad impressions. The system may determine whether to bid for a placement opportunity by consulting the list of eligible user identifications from the list of eligible users when an impression count reaches a threshold and adds the user identifications to a saturation list. The system may determine if a user identification is on a saturation list and add a user identification to an eligible list upon a determination that the user identification is not on said saturation list. The system may manage a bidding process including reviewing parameters of an auction opportunity wherein one of the parameters is user identification, qualifying the auction opportunity based on eligible user count and user exposure count, bidding on a qualified auction opportunity, and updating the user exposure count in the event of an auction success. The system may bid on an auction opportunity when said user ID corresponds to an eligible user ID. The system may increment the user exposure count upon a successful auction award. The system may compare the use exposure count to a saturation exposure count.

Various objects, features, aspects, and advantages of the present invention will become more apparent from the following detailed description of preferred embodiments of the invention, along with the accompanying drawings in which like numerals represent like components.

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

FIG. 1 schematically shows a system for a real-time bidding ad exchange.

FIG. 2 shows a schematic of a bidding platform server.

FIG. 3 shows an embodiment of a system for cross platform real-time bidding data augmentation.

FIG. 4 shows a schematic of a tracking pixel server.

FIG. 5 shows an example of content in a tracking pixel database.

FIG. 6 schematically shows a flow diagram of an embodiment for cross platform real-time bidding data augmentation.

FIG. 7 schematically shows a flow diagram of an embodiment for maximizing the number of users who receive an optimal number of ad impressions by reach limitation.

FIG. 8 schematically shows a flow diagram of an embodiment for imposing further constraints on a reach limitation of eligible users.

FIG. 9 shows a bidding platform server with optimized segment management.

### DETAILED DESCRIPTION OF THE PREFERRED EMBODIMENT

Before the present invention is described in further detail, it is to be understood that the invention is not limited to the embodiments described, as such may, of course, vary. It is also to be understood that the terminology used herein is for describing embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by prior invention. Further, the dates of publication provided may be different from the actual publication dates, which may need to be independently confirmed.

The invention is described in detail with respect to preferred embodiments, and it will now be apparent from the foregoing to those skilled in the art that changes, and modifications may be made without departing from the invention in its broader aspects, and the invention, therefore, as defined in the claims, is intended to cover all such changes and modifications that fall within the true spirit of the invention.

The system may rely on real-time bidding. Real-time bidding may be used to place bids for electronic media impression auctions and, if the bid is won, the buyer's ad is instantly displayed on the publisher's site.

A key advantage of real-time bidding is the value of ads are optimized per impression, which allows advertisers to maximize ad effectiveness and publishers to maximize the value of their ads. Real-time bidding lets advertisers manage and optimize ads from multiple ad-networks by granting the user access to a multitude of different networks, allowing them to create and launch advertising campaigns, prioritize networks and allocate percentages of unsold inventory.

The system may rely on tracking pixels for confirmation of ad placement. A tracking pixel may be a small (usually transparent) GIF or PNG image that is embedded in an HTML page, usually a webpage or the content of an email. Tracking pixels may also use HTML IFRAME, style, script, input link, embed, object, and other tags. When a user opens a webpage or email, such image and other information is downloaded. This download requires the browser to send a request to the server storing that image or information, allowing the party running that server to keep track of the HTML page.

According to an advantageous feature, tracking pixels may be fetched from a third-party ad server, not from the server the main webpage was fetched from. Because of this, advertisers may gather information about visitors when visitors request HTML content from the main webpage server and can thus track certain properties of the browsing habits of web users.

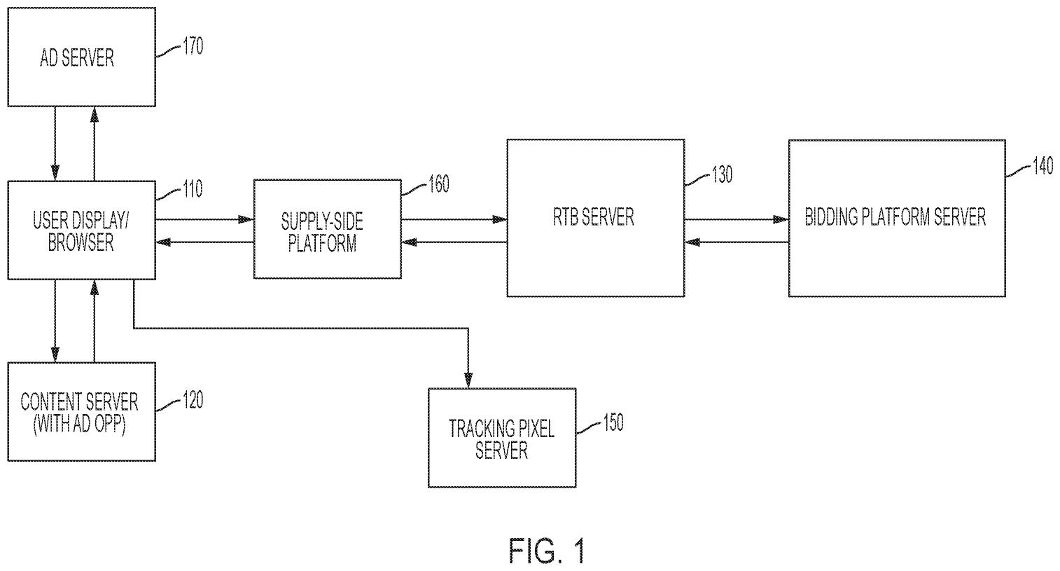

FIG. 1 schematically shows a system for a real-time bidding ad exchange. FIG. 1 shows a user display or browser 110 that displays an ad to a user. The user display or browser 110 may be attached to a stationary device or mobile device such as a smart phone, tablet or other device. The user display or browser 110 may be configured to access web sites using HTTP protocol or another protocol. The webpage accessed by the user display or browser 110 may contain Internet HTML reference to a content server 120. Upon the user accessing the content of the publisher, the content server 120 returns the requested content to the user display or browser 110, which may be in the form of HTML. The returned HTML may contain an “ad opportunity” to display an ad. The HTML may direct the user display or browser 110 to an ad network or ad exchange to retrieve ad content.

In the embodiment shown in FIG. 1, HTML directs the user display or browser 110 to retrieve an ad from a supply-side platform 160. The supply-side platform 160 may optionally perform operations on the ad request, such as acquiring information about the user from a data provider or the display or browser 110. The supply-side platform 160 then sends the ad request to an RTB server 130. The RTB server 130 may be connected to bidding platform servers 140 (only one shown for clarity). After receiving the ad opportunity, the RTB server 130 may be configured to “auction” the ad opportunity to the bidding platform servers 140.

Each bidding platform server 140 may be bidding on behalf of one or more advertisers or campaigns. The bidding platform servers 140 may use internal logic to determine how to value a bid for an ad, based on several criteria regarding the ad or campaign. In addition, the bidding platform servers 140 may use the information about the ad opportunity and the user requesting the ad, as provided by the RTB server 130, to assess the value of the ad opportunity to the advertiser. The bidding platform servers 140 then send their bids for the ad opportunity to the RTB server 130, which determines which bid will fulfill the ad opportunity.

A content publisher may have the capacity to preempt an auction by maintaining a publisher ad server. The publisher ad server may have pre-cached criteria for which, when satisfied, prompts delivery of the ad opportunity to the RTB server. In this case, the criteria are satisfied, and the HTML code directs the user display or browser 110 to the publisher ad server rather than the RTB server 130. The functions of the publisher ad server could also advantageously be performed by the supply-side platform 160.

When an ad opportunity if fulfilled by the RTB server 130, the bidding platform server 140 (or equivalent) of the winning bid passes instructions to the RTB server 130 for retrieving the ad. In the embodiment shown in FIG. 1, these instructions are passed to the supply-side platform 160, and then to an open HTTP connection of the user display/browser 110. In another embodiment, the instructions may be passed through additional locations such as a publisher ad server, or the RTB server 130 may pass the instructions directly to the user display/browser 110.

The user display/browser 110 then follows the instructions to retrieve the ad from an ad server 170. In one embodiment, the ad server 170 may be advantageously contained within the bidding platform server 140. Upon receiving the request for the placement of an ad, the ad server 170 may deliver the ad to the user display/browser 110 or may deliver the address of the ad to the browser 110, which in turn may retrieve the ad from the address indicated.

The ad delivered to the user display/browser 110 may be embedded with a tracking pixel or web beacon to track the ad impression. A tracking pixel may be a small GIF or PNG image that is embedded in an HTML page. The image may be transparent or may be the same color as the background. Tracking pixels may also use HTML IFRAME, style, script, input link, embed, object, and other tags to track the ad impression. The tracking pixel may include an external link to a tracking pixel server 150. When the HTML code is processed by the user display/browser 110, the user display/browser 110 executes the code of or associated with the tracking pixel. This may be a report to a tracking pixel server 150 or a request for content from the tracking pixel server 150. The content from the tracking pixel server 150 or the code associated with the tracking pixel may cause tracking pixel data to be transmitted. Tracking pixel data may include one or more identifiers and/or other optional additional data. The identifier may include one or more of IP addresses and/or device ID's. Optional additional information may include the device ID, placement details of the digital ad on a display screen of the device, type of website or email used, time the email was read, or website was visited, activities on the website during a session, operating system used (which may be indicative of the use of mobile devices), type of client used (for example a browser or mail program), and client screen resolution. Tracking pixels may facilitate tracking ads delivered as web content or content delivered by email.

Once the tracking pixel server 150 receives the tracking pixel and tracking pixel data, the tracking pixel server 150 may record the tracking pixel data in the tracking pixel server logs.

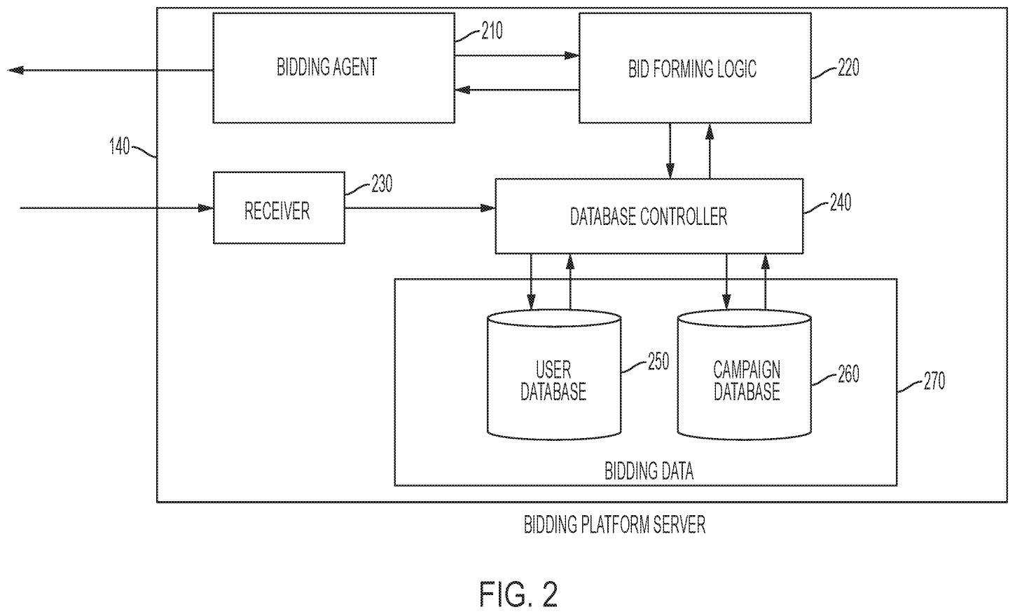

FIG. 2 shows a schematic of a bidding platform server. FIG. 2 shows a receiver 230 that is configured to receive an ad opportunity. The bid may include information such as the user's IP address, device ID, and user data such as demographic information. The receiver 230 may be configured to send the ad opportunity to a database controller 240. The database controller 240 may have access to several types of data that may be used to inform bids. A user database 250 may contain data indexed by users' IP address or device ID and may also contain information such as personal or demographic information, user preferences, and prior advertising exposure of the user.

A campaign database 260 may include information regarding the desired criteria for ad opportunities. For example, an ad campaign may be set up to target a certain geographic region or certain demographic of people. The campaign database 260 may also include information such as the budgetary constraints of the campaign or specification of content for ad placement. For example, an ad campaign may limit the total spend amount, spend per ad, and specify websites for ad placements.

The collection of data that informs the bid may be referred to as the bidding data 270. While the embodiment in FIG. 2 shows a user database 250 and campaign database 260, any number of databases may be maintained to inform bidding. For example, an ad for sunscreen may find greater value in fulfilling ad opportunities based on weather. In this case, the bidding data 270 may include an additional database that contains information regarding the current weather by geographic location.

The database controller 240 may inform the bid forming logic 220 of the bid opportunity. The bid forming logic 220 may be configured to assess the bid opportunity based on the information regarding the bid opportunity and the bidding data 270. The bid forming logic 220 may use any number of methods for valuing bids based on datasets, as is known in the art. For example, some approaches may simply use a weighed sum of criteria vectors for resource constrained applications, while other sophisticated methods may use machine learning techniques such as Bayesian Classifiers, cluster analysis, decision trees, and artificial neural networks.

U.S. Pat. No. 9,129,313 B1 entitled, “System and method for optimizing real-time bidding on online advertisement placements utilizing mixed probability methods” is expressly incorporated herein by reference, discloses a system and method for optimizing real-time bidding on advertisements by utilizing mixed probability methods. The system assigns several probability scores based on various criterion, and then calculates a combined probability score and threshold based on these scores when a real-time bid request is received.

The bid forming logic 220 may establish and transmit bidding parameters to the bidding agent 210. The format of this communication may depend on the embodiment. In a real-time bidding environment in which the RTB server auctions the ad opportunity to the highest bidder, the communication from the bid forming logic 220 to the bidding agent 210 may be in the form of the bid amount. The bidding agent 210 may be configured to interact with an RTB server.

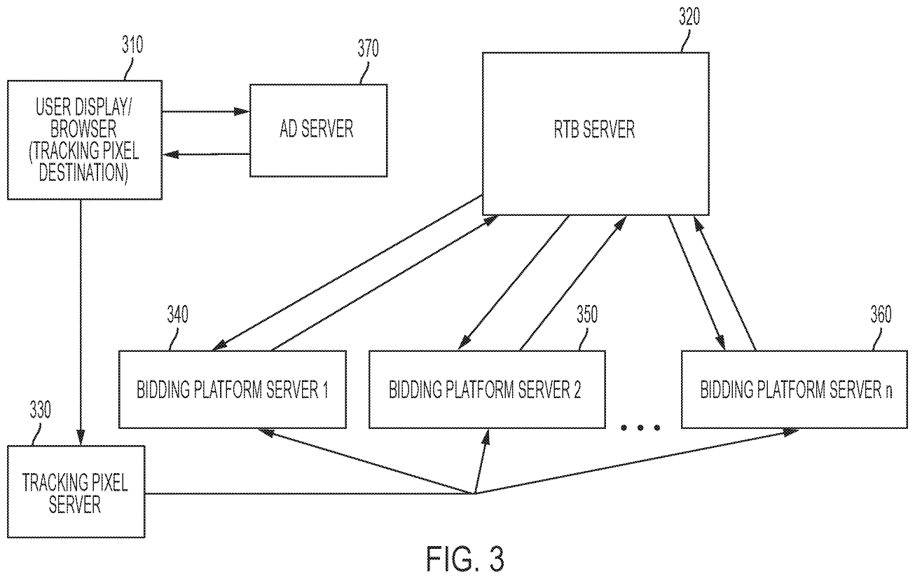

FIG. 3 shows an embodiment of a system for cross platform real-time bidding data augmentation for use with an RTB server 320. As shown previously in FIG.1, the user display/browser 310 follows the instructions to retrieve the ad from the ad server 370. Upon receiving the request for the placement of an ad, the ad server 370 delivers the ad to the user display/browser 310. The ad delivered to the user display/browser 310 may have an embedded tracking pixel to track the ad impression.

The tracking pixel includes an external link to a tracking pixel server 330. When the HTML code is processed by the user display/browser 310, the user display/browser 310 sends the tracking pixel data to the tracking pixel server 330. Tracking pixel data may include identifiers and may include other optional additional data.

The tracking pixel server 330 may be in communication with a plurality of bidding platform servers 340, 350, 360. The embodiment in FIG. 3 shows three bidding platform servers, but it will be appreciated by those skilled in the art that any number may be used depending on the embodiment. According to an advantageous feature, the tracking pixel server 330 may facilitate coordination between bidding platforms severs 340, 350, 360.

For example, an advertiser may engage multiple bidding agencies for a campaign or related campaigns. Multiple bidding platform servers currently have no way of knowing the status of complimentary campaigns. To facilitate coordination, each bidding platforms severs 340, 350, 360 associated with a campaign or related campaigns may embed ads with tracking pixels that have the same address. The embodiment in FIG. 3 shows that this address may be a single tracking pixel server 330. In another embodiment, bidding platforms sever 340, 350, 360 may address tracking pixels to different tracking pixel servers. In this embodiment, each tracking pixel server is configured to either share tracking pixel data or forward tracking pixel data to a common tracking pixel server. In addition, or alternatively, multiple tracking pixel servers may forward tracking pixel data to one or more bidding platform servers.

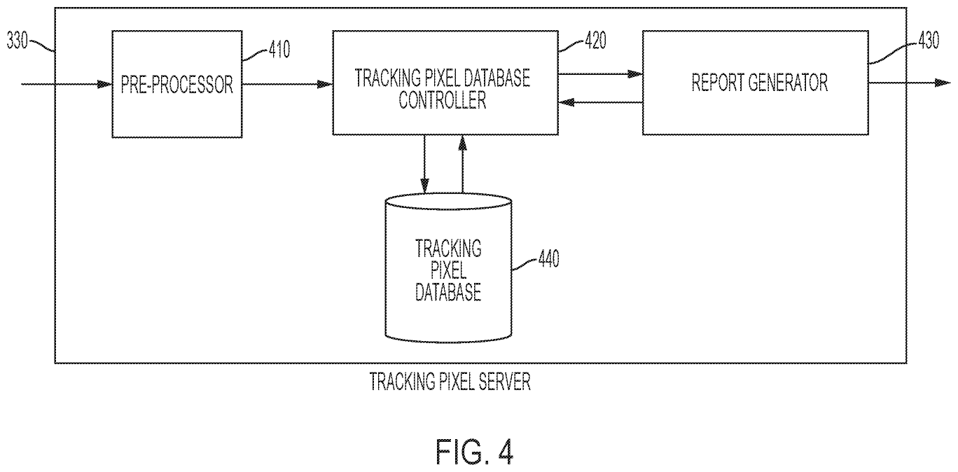

FIG. 4 shows a schematic of a tracking pixel server. According to an advantageous feature, the tracking pixel server may be placed on a standalone server or integrated with another component of the system, such as a bidding platform server. A pre-processor 410 may receive the tracking pixel data, and optionally, additional data. The pre-processor 410 may format and segregate the incoming information according to the requirements of the embodiment. After converting the information into an acceptable format, the pre-processor 410 may deliver some or all the information to a tracking pixel database controller 420. The tracking pixel database controller 420 may be connected to a tracking pixel database 440 that maintains tracking pixel data of a plurality of bidding platforms. The tracking pixel database controller 420 may log the receipt of the tracking pixel data, as well as any other metadata such as a timestamp of the receipt, in the tracking pixel database 440.

The tracking pixel database controller 420 may also update a tracking pixel database 440 with the received tracking pixel data according to the embodiment. The tracking pixel database controller 420 may query the tracking pixel database 440 to determine if the identifier of the tracking pixel is already found in the tracking pixel database 440. If the identifier is not found in the tracking pixel database 440, the tracking pixel database controller 420 may direct the tracking pixel database 440 to create a new user entry. User entries may be indexed by one or more identifiers, such as the IP address or device ID. If the identifier of the tracking pixel is already found in the tracking pixel database 440, the tracking pixel database controller 420 may update the existing user entry.

In addition, or alternatively, a report generator 430 may be maintained to periodically inform the plurality of bidding platform servers of received tracking pixels and tracking pixel data. The format and frequency of this informing depends on the embodiment. In one embodiment, the report generator 430 may inform the plurality of bidding platform servers of a received tracking pixel (and tracking pixel data) every time the tracking pixel server receives a tracking pixel. In another embodiment, the report generator 430 may maintain a cache of received tracking pixels and tracking pixel data and send aggregated tracking pixel data at specified intervals. The tracking pixel database 440 may also be formatted to maintain a cache of tracking pixel data that has been received since the last time the report generator 430 provided the plurality of bidding platform servers with a report of tracking pixel data.

The report generator 430 may also be configured to track campaigns or related campaigns. Campaign information, as well as other information (such as information from external sources including third-party information or user information) that may assist in optimizing bids such as current event data, may be stored in the report generator 430 or another location, depending on the implementation. Advertisers may specify certain limits, thresholds, or other benchmarks with a campaigns or related campaigns. For example, an advertiser may want to limit the number of ad placements across all bidding platforms for a campaign or may want to set a minimum or maximum number of unique users across all bidding platforms. The report generator 430 may be able to inform the plurality of bidding platform servers of the status of benchmarks.

The report generator 430 may use such campaign information in conjunction with aggregated tracking pixel data in the tracking pixel database 440 to make determinations as to the status of reaching campaign benchmarks. After making such determinations as to the status of a campaign benchmark, the report generator 430 may to command or request that one or more bidding platform servers change their bidding behavior. For example, an advertiser may want to specify an allowable range of the number of ads in a certain geographic region per week. If the report generator 430 determines that the maximum number of ads has been reached, the report generator 430 may command bidding platform servers to stop placing bids for that ad. Conversely, the report generator 430 may request that the bidding platform servers change their bidding criteria to place more bids if the campaign is in danger of not meeting an ad quota.

A tracking pixel process, whether dedicated or centralized to disparate bidding platforms may be helpful in bid management. A report generator 430 may use aggregated tracking pixel data in the tracking pixel database 440 to assist in other actions that facilitate satisfaction of ad placement criteria. In one embodiment, the report generator 430 may be configured to periodically assess certain metrics, such as the reach of an advertisement. For example, the report generator 430 may request from the tracking pixel database controller 420 the geographic location of ad placements over a certain time period. The report generator 430 may then generate aggregate statistics and assess the reach of the campaign in a geographic location. Such aggregate statistics may be compiled into reports and sent to bidding platform servers to further inform bidding. Such reports may also be sent to advertisers to allow advertisers the opportunity to assess the status of the campaign. In another embodiment, report generator 430 may use such campaign information in conjunction with the aggregated tracking pixel data in the tracking pixel database 440 to compare against campaign benchmarks, as discussed above. In this embodiment, the report generator 430 may make determinations that result in commands or requests that bidding platform servers change their bidding behavior. In yet another embodiment, report generator 430 may be configured to periodically assess certain metrics, such as the reach of the advertisement.

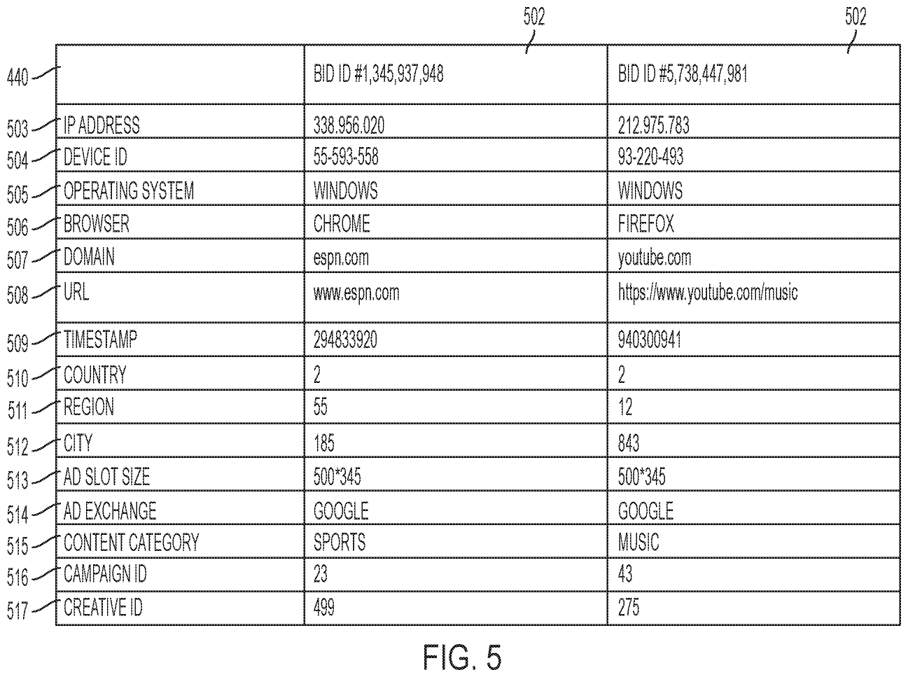

FIG. 5 shows an example of content in a tracking pixel database 440. Tracking pixel data may be indexed by a unique identifier such as a Bid ID 502 (as shown), and/or another identifier such as the IP address 503 and/or device ID 504. The set of optional tracking pixel data is meant to be illustrative, not exhaustive and may include such information as operating system 505, browser 506, domain 507, URL 508, time stamp 509, country 510, region 511, city 512, ad slot size 513, ad exchange 514, content category 515, campaign ID 516, and creative ID 517.

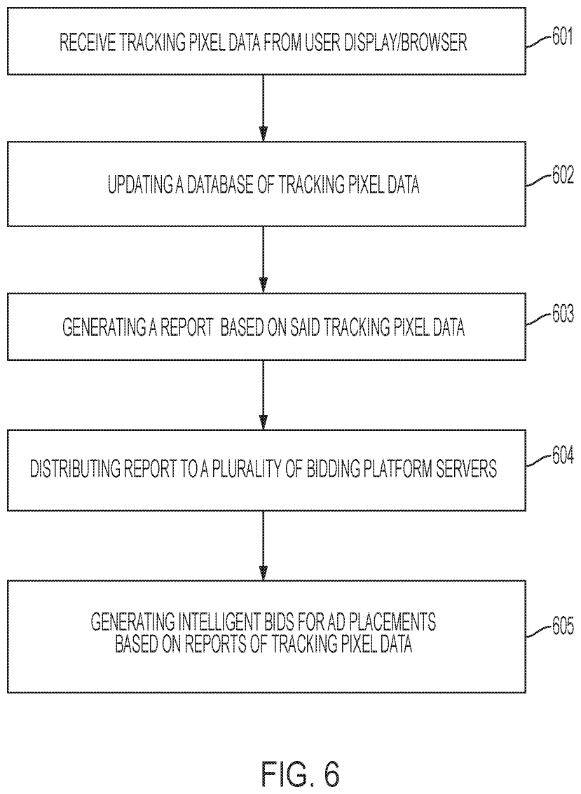

FIG. 6 schematically shows a flow diagram of an embodiment for cross platform real-time bidding data augmentation. The tracking pixel server 330 receives the tracking pixel data from the user display/browser 310 in step 601. The receiving step 601 may involve pre-processing to format and segregate incoming information according to the requirements of the embodiment. A database of tracking pixel data may be updated with the received tracking pixel data in step 602. The updating operations 602 may depend on the tracking pixel data and implementation. For example, tracking pixel data with an identifier that is unknown to the tracking pixel database 440 may require the tracking pixel database controller 420 direct the tracking pixel database 440 to create a new entity entry, while a known identifier may result in the tracking pixel database controller 420 updating the existing entity entry.

A report of the tracking pixel data may be generated by the report generator 430 in step 603. The report may represent tracking pixel data from more than one bidding platform server, and thus the resulting report may provide augmented data to a bidding platform server that was previously unavailable to the individual bidding platform servers. The reports may take a variety of different forms, depending on the embodiment. In one embodiment, the report generator 430 may be maintained to provide aggregated but unadulterated tracking pixel data to one or more bidding platform servers. In this embodiment, bidding platform servers may each analyze the tracking pixel data individually to optimize bidding strategies.

In another embodiment, report generator 430 may use such campaign information in conjunction with the aggregated tracking pixel data in the tracking pixel database 440 to compare against campaign benchmarks, as discussed above. In this embodiment, the report generator 430 may make determinations that result in commands or requests that bidding platform servers change their bidding behavior. In yet another embodiment, report generator 430 may be configured to periodically assess certain metrics, such as the reach of the advertisement.

In each embodiment of step 603, the result is that the report is delivered to bidding platform servers in step 604. The nature of how the report is delivered depends on the specific implementation of the tracking pixel server. As discussed above, the tracking pixel server may be placed on a standalone server or integrated with another component of the system, such as a bidding platform server.

The report may be used to generate intelligent bids for ad placements in step 605. In one, bidding platform servers may update the bid forming logic 220 with the report. Because the report is generated with augmented data, the bid forming logic 220 may alter bid placements. In an embodiment in which the report contains aggregated tracking pixel data form, the report may be used to populate the user database 250, the campaign database 260, or any other form of data in the bidding data 270. According to this embodiment, the bid forming logic 220 may alter bid placement parameters based on data from other bidding platform servers.

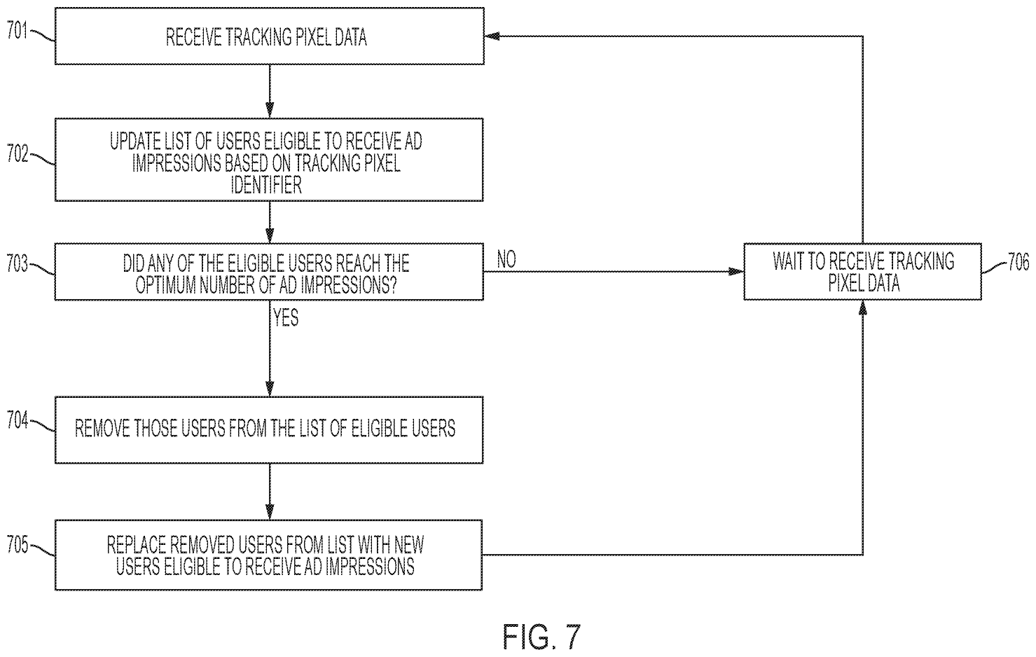

FIG. 7 schematically shows a flow diagram of an embodiment of a reach limitation system for maximizing the number of users who receive an optimal number of ad impressions by imposing reach limitation. Tracking pixel data may be received from a cross-platform database controller 420 or, in a standalone implementation, because of delivery of ads in 701. Tracking pixel data may be a single tracking pixel or a plurality of tracking pixels aggregated over a period. The tracking pixel data may be used to update a list of users eligible to receive ad impressions based on tracking pixel identifier in 702. A list of eligible users may be generated on the fly or may be received from the advertiser or other third party. The list may be indexed by one or more identifiers, depending on the embodiment. The relevant identifier of the tracking pixel data may correspond to the identifier used to index the list of limited set of eligible users, such as the IP addresses and/or device ID.

A set of user records may track the number of impressions for each user. Once users have received a threshold number of impressions, they may be identified as ineligible at step 703. The optimum number of impressions may be within a specified range or may depend on the embodiment. If both the minimum number of impressions (before the ad placement reaches the desired effectiveness) and the threshold number of impressions (after which the impression has little or no further value) are known, the optimum number may be chosen to be more than the minimum number, but less than the threshold. How impressions are counted may also depend on the embodiment. For example, the advertiser may wish to limit the number of impressions per user for each ad placement or may wish to limit the aggregate number of impressions per user for the entire campaign.

The reach limitation to maximize optimal impressions may be managed in several ways. A list size may be established for a campaign and users may be added to the list based on bidding opportunities until the list is fully populated. Once the lists populate, no further users will be added until other users are removed. It is possible to maintain a list of removed users to avoid the same user being re-added after having been removed. Each time a user receives an ad impression, typically determined upon receipt of tracking pixel data, an impression count may be incremented. In a simple embodiment, the cap for the impression count could be established as a fixed number. Once a user receives the cap number of impressions, the user is removed from the eligible user list and/or identified as an ineligible user. The removal and/or identification as an ineligible user frees up a spot on the list, and a new user then may be added without being disqualified by a closed user list.

According to an enhancement, the optimal number of impressions may be a range whereby once a user achieves the number of impressions corresponding to the lower limit of the optimal range of impressions, a spot on the list may be opened, but the user will not be removed from the list or designated as ineligible until that user receives a number of impressions corresponding to the upper limit of the optimal range.

According to a further enhancement, further spots on the list may be allocated regardless of the number of impressions to individual users based on passage of time. For example, if the optimal range is 7 to 10 impressions, and a user has been on the list for a certain period without achieving the lower limit of the optimal range of impressions, a spot on the list may be opened. According to another enhancement, a list may be opened as a campaign draws closer to an end if the campaign goal for number of overall impressions has not been met or a campaign is not on pace to achieve the overall impression goal.

As discussed above, if one or more users reach the optimum number of ad impressions, those users may be removed from the list of eligible users in 704. The removed users may be replaced with new users to be eligible to receive ad impressions in 705. The system may wait for further tracking pixel data to be received in 706. Other metrics may also be periodically assessed to determine whether to perform additional functions on the list of eligible users, such as the overall reach of the campaign or budget constraints. For example, the replacement of eligible users in 705 may be slowed or stopped entirely when the total budget of the campaign is close to being reached.

The reach limitations may be tracked at an individual bidding agent, or if cross-platform augmentation is used, at a tracking pixel server. In either case, the reach limitation may be governed by an automatically-populated list. The entries in the list may be made when a successful bid for an ad placement is awarded. A user ID may be added to the list with a placement count. Each time an opportunity is received that satisfied bidding criteria, the list is consulted to determine if the user is eligible to receive the placement. If the user is on the list, the bid is made. If the bid is successful, the placement count for the user may be incremented. Once the placement count reaches a threshold, the user may be removed from the eligible list and placed on a saturation list. If the eligible list is not full and the user is not on a saturation list, then the bid may be placed. If the bid is successful, the user will be added to the eligible list.

An RTB server may be configured to provide various data fields to a receiver 230 of a bidding platform server. This may be accomplished by program instructions retrieved when a reference to an ad opportunity is encountered by a user browser or other display program. Advantageously, the HTML instruction acquire and transmit user identification data and current data about the user activity and platform. This may be combined with historical information regarding the user. The user may be identified by some user ID, cookie data, IP address, or MAC address. The historical data may be updated with relevant current information. Some or all the data may be provided to a bidding platform server 140. The bidding platform server 140 may combine the data with other data it may have concerning the user, for example, television viewership, current and/or historical and campaign data for formulating a bid in the bid forming logic 220. In some platforms, the ad opportunity may be generated in an app, such as a mobile game app. An identification of the app that generated the ad opportunity may be delivered to the bidding platform server 140.

Many times, a user may be watching television at the same time as the user is engaged with a second screen such as a smartphone, tablet, or computer. Part of the bidding logic may be based on television viewership or media consumption, which may be reported by a media device such as a television or set top box or may be obtained using automated content recognition (ACR) by monitoring ambient audio at the second screen device or another probe.

By correlating viewership data with ad opportunity source information obtained with a bid request, it is possible to discover the apps that viewers of a program of interest are using or the web activity that led to the ad opportunity. The identification of app use (web use) correlations to media of interest allows an advertiser to bid on opportunities from other users encountering the same app regardless of viewership data. This inferred qualification may be useful in bid formulation.

The same process may be used to infer qualification by correlating television viewership data with a website generating an ad opportunity. For example, if it is determined that the set of users who viewed a show were also visiting a certain website or using an app, the advertiser may target ad bids to other users of the app or visitors to the website for whom viewership data is unavailable.

Another bid management feature can be established to enhance distribution of ad placements. Once an otherwise eligible bid based on viewership parameters is established, the bidding logic could further check viewership subcategory identification against a placement log and a subcategory threshold table. If the number of entries in the log for successful placements in a subcategory exceeds the limit set in the subcategory table, then bidding can be prohibited. Each time an ad is placed, the log may be updated.

Advertisers may wish to limit reach based on users' viewership of content, such as TV content. Viewership of content may be acquired through several methods, including automatic content recognition. Automatic content recognition refers to the ability to identify a content element within the proximity of a probe or sensor, audio, video or image, based on sampling a portion of the audio, or video, or image, processing the sample and comparing it with a reference. For example, an automatic content recognition technology that samples audio may be used to identify cable or network broadcast content (programs).

Using technology such as automatic content recognition or any other method, advertisers may wish to target advertisements according to users' overall viewership information of content. According to this embodiment, an advertiser may limit reach by issuing advertisements only to viewers of a set of pre-selected programs. For example, an advertiser may wish to promote a product only to viewers who have seen one or more events of the 4 major sports. This may be achieved by limiting the reach of the campaign to a set of users that have viewership data corresponding to programs comprising events of the 4 major sports. In addition, any combination of criteria may be utilized to limit reach, such as by requiring users to have viewed multiple programs. The reach limitation may be coordinated across multiple bidding platforms using the afore-described tracking pixel server. The reach limitation may also be performed on a single bidding platform. For example, advertisers may limit the reach of the campaign to viewers within a certain geographic region who have seen one or more events of the 4 major sports.

The reach of the ad placement or campaign may be further limited by demanding additional criteria within limitations. In this embodiment, advertisers may effectively create sub-classes within the list of users eligible to receive ad impressions for a campaign. For example, in addition to limiting eligible users to viewers who have seen one or more events of the 4 major sports, it may be desirable to limit placements to hockey watchers to a pre-determined number but allow a greater number to viewers of other events. For example, an advertiser may wish that no more than 15% of placements be given to hockey watchers while baseball viewers may receive up to 50% of placements.

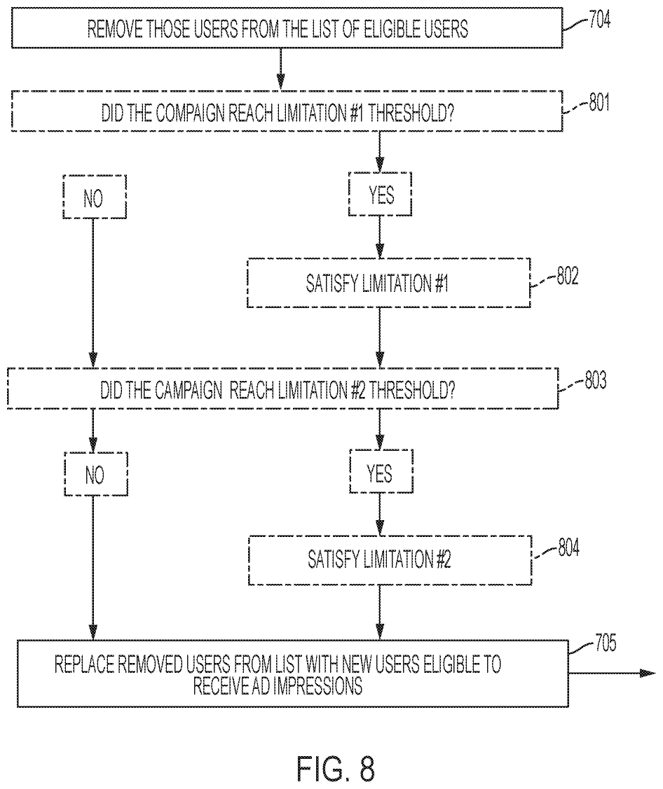

FIG. 8 schematically shows a flow diagram for imposing further constraints on a reach limitation of eligible users. After one or more users reach the target number of ad impressions and are removed from the list of eligible users in 704, the system may ask whether the campaign or ad placement has reached any limitations or benchmarks in 801 and 803. For example, an advertiser may want to provide the optimal number of ad impressions to 1000 users who view hockey and 1000 users who view basketball. In 801, the system would determine if the received tracking pixel data resulted in 1000 users who view hockey reaching the optimal number of ad impressions. If it did, the system would remove them from the list of users eligible to receive ads in 802. The system would then repeat the steps for basketball viewers in 803 and 804. In addition, steps 802 and 804 may be any task that is required by the limitation and are not confined to removing eligible users. For example, a campaign limitation may require a minimum number of users that meet a criterion. In this case, steps 802 or 804 may involve adding eligible users. The two campaign limitations in FIG. 8 are illustrative, not exhaustive of the limitations that advertisers may impose. Any number of limitations may be used, depending on the embodiment.

In another embodiment, steps 801, 802, 803, and 804 could be performed at a different time. For example, these steps could be inserted between steps 702 and 703 when limitations on the reach of the campaign do not depend on the number of users that reach the optimal number of ad impressions. This may be the case when an advertiser wants to impose a budget on ads for a group or wants to set a maximum number of bids for group.

Advertisers may wish to limit reach based on tracking pixel data or other metadata, such as the app which is requesting the ad placement. It may be important for advertisers to strictly manage bidding so that ads are not concentrated in a limited number of apps. The use of ad opportunity source to limit reach is implemented by the system maintaining information identifying ad opportunity source, number of placements to an ad opportunity source, and opportunity source threshold level. The RTB server 130 may provide to one or more platform servers 140 ad auction opportunity information which in this embodiment will include an ad auction opportunity identification, an ad opportunity source, and other information about the opportunity and/or user. The ad opportunity information is acquired by the receiver 230 and processed by the database controller 240. In this embodiment, the campaign database 260 may include the information identifying ad opportunity source, number of placements to an ad opportunity source, and the ad opportunity source threshold. The opportunity source may be an app or a web resource such as a website domain or web page or another source identification.

The database controller 240 also receives tracking information triggered by processing a tracking pixel. The tracking information is indicative of a successful placement. The successful placement triggers the database controller 240 to record the placement in the campaign database 260.

Upon receiving a bid opportunity indicating bid opportunity source, the database controller 240 may evaluate the successful placements corresponding to an opportunity against an opportunity source threshold stored in the campaign database 260. The result of that comparison may inform the bid forming logic 220 in its bidding process.

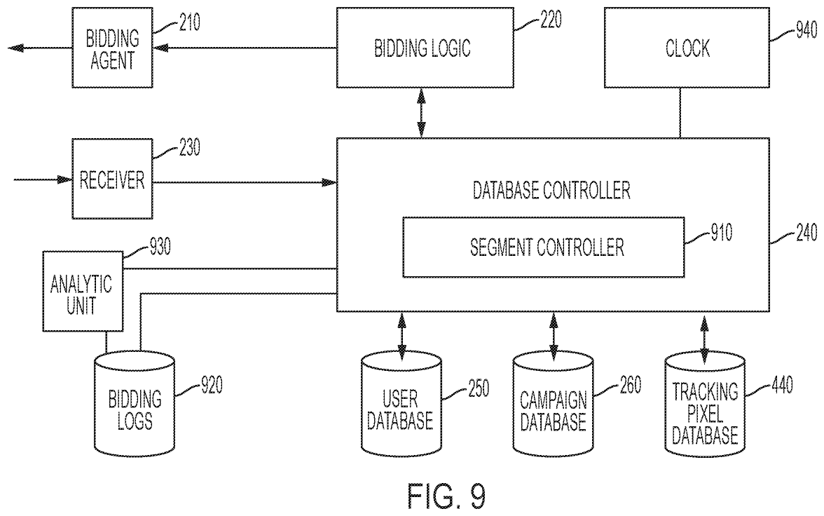

FIG. 9 shows a bidding platform server with an optimized segment performance management. The rate of successfully establishing advertisement impressions depends, inter alia, on the rate of bids placed on qualifying advertisement opportunities, the amount bid on qualifying advertisement opportunities, and on external factors outside the knowledge and control of a bidding agent. The external factors may include competing bidders with targeting criteria that overlaps the targeting criteria of the bidding agent.

Accordingly, a campaign may have an objective to fill its goals for one or more targets over the time of the campaign. The amount bid may be set so that a sufficient rate of auction successes is maintained, knowing that not all bids placed will be winning bids. If the amount bid does not achieve a sufficient rate of winning bids, then the amount may be increased when campaign objectives specify. When campaign performance rate exceeds campaign objectives, the rate of successful bids may be reduced by reducing the amount bid and reducing the frequency of bidding on qualifying opportunities. The complexity of rate optimization is enhanced when the complexity of campaign objectives is more complex. The system is provided to enhance management of bidding when the campaign objectives include specification of objectives for more than one segment.

The bidding platform server may include a bidding agent 210 as previously described. The receiver 230 receives information concerning an advertisement opportunity from a real-time bidding system. The ad opportunity information is provided to database controller 240. Database controller 240 includes a segment controller 910 for optimizing segment performance. Segment performance is optimized by allocating the campaign resources on bid opportunities among specified segments according to a system for managing advertising impressions between segments. In addition to the afore-described information, the campaign database 260 will include information identifying target distribution of target opportunities by segment of a targeted population. For example, a first segment may be targeted for 50% of the budgeted impressions. A second segment may be targeted for 30% of budgeted impressions, and a third segment may be targeted for 20% of budgeted impressions. Furthermore, the segments need not be the same size and the system may not even be aware of the respective size of the segment. Furthermore, the segments may be prioritized so that during the campaign period, to the extent that not all budgets are filled, the system will be able to adjust bid forming to prioritize segments. Information in a user database 250 is available to augment the bidding opportunity data obtained from receiver 230. In addition, tracking pixel database 440 may be accessed by a segment controller 910 so that performance may be monitored and bidding logic parameters of the bidding logic 220 may be altered on the fly in order to meet campaign objectives. The database controller 240 may be connected to a clock 940 so as to be able to track campaign time frames and associate a time with various recorded events in the databases and logs. Bidding logs 920 store records of each bid opportunity satisfying campaign criteria, the bid amounts, and results of the bidding. The bidding logs 920 contain a bid and campaign history. An analytic unit 930 may be provided in order to evaluate bid performance in order to inform the operation of bidding logic 230, in particular advanced functions, to facilitate modification of bidding logic on the fly during a campaign. The segment controller 910 is provided to control the ratio of bids made on the total number of ad opportunities in each segment. The segment controller may adjust the bid amounts in order to achieve an acceptable rate of successful bids to satisfy the campaign and segment objectives. The segment controller 910 may be more efficient if its bid allocation among segments and bid amounts are adjusted over the course of a campaign. The segment controller 910 monitors the duration of the campaign and the segment performance as the campaign progresses. This allows adjustments to bid forming logic to optimize performance.

The invention is described in detail with respect to preferred embodiments. It will be apparent to those skilled in the art that certain changes and modifications may be made without departing from the invention in its broader aspects, and the invention, therefore, as defined in the claims, is intended to cover all such changes and modifications that fall within the true spirit of the invention.

The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A real-time bidding system comprising:
a receiver configured to receive information identifying a real-time advertisement opportunity auction including an identification of an advertisement target;
a user database containing information about users including user activity and demographics;
a campaign database containing information specifying campaign parameters including ad placement objectives for targeting and target segments;
a tracking database containing information identifying and concerning advertisement placements and impressions;
a database controller connected to said receiver, said user database, said campaign database, and said tracking database configured to receive said information identifying a real-time advertisement auction opportunity, using said information identifying a real-time advertisement auction opportunity to access information in said campaign database and use accessed information to query said tracking pixel database;
a segment controller configured to assign a segment identification to an advertisement opportunity auction based on said campaign database specification of said targeting segments and information concerning said advertisement opportunity auction and said user database;
a bid forming server responsive to said database controller to establish a bid decision and bid amount for real-time advertisement auction opportunity access based on segment performance and campaign progress and time of campaign.

2. The real-time bidding system according to a claim 1 further comprising a segment bidding manager connected to said database controller and configured to modify billing parameters based on campaign segment performance.

3. The real-time bidding system according to claim 2 wherein said segment bidding manager further comprises campaign bid log storage and campaign progress analytics.

4. The real-time bidding system according to claim 1 wherein said identification of an advertised target is a device identification.

5. The real-time bidding system according to claim 1 wherein said identification of an advertisement target is a user identification.

6. The real-time bidding system according to claim 1 wherein said identification of an advertisement target is a network address.

7. The real-time bidding system according to claim 1 wherein said information about a user's activity comprises TV viewing data.

8. The real-time bidding system according to claim 1 wherein said information about a user's activity comprises historical advertisement impressions.

9. The real-time bidding system according to claim 1 wherein said information about a user's activity comprises location history.

10. The real-time bidding system according to claim 1 wherein said information about a user's activity comprises AP usage.

11. The real-time bidding system according to claim 1 wherein said information about a user's activity comprises media consumption.

12. A method for managing a bidding process comprising the steps of:
reviewing parameters of an advertisement opportunity auction wherein one of said parameters is a user identification;
qualifying said advertisement opportunity auction based on targeting parameters;
categorizing a qualified advertisement opportunity auction based on user segment;
applying bid forming logic to said advertisement opportunity auction on the basis of user segment and campaign data specifying segment parameters and campaign progress.
